(19) United States
(12) Patent Application Publication
(10) Pub. No.: US 2004/0046638 A1
(43) Pub. Date: Mar. 11, 2004

(54) Terminal lock system comprising key device carried by user and terminal-associated device incorporated in terminal device

(75) Inventor: Haruo Kawasaki, Minato-ku (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/656,284

(22) Filed: Sep. 8, 2003

(30) Foreign Application Priority Data
Sep. 10, 2002 (JP) 2002-264072

(51) Int. Cl. G06F 7/04

(52) U.S. Cl. 340/5.61; 340/5.74

(57) ABSTRACT

A terminal-associated device is combined with a terminal device that is to be protected against unauthorized use, and a key device is carried by the user. The terminal-associated device has a memory for storing information of the key device. When the user who is carrying the key device moves away from the terminal device combined with the terminal-associated device until the terminal-associated device and the key device are no longer capable of connecting to each other based on a short-range radio communication technique such as Bluetooth, radio LAN, or the like, the terminal-associated device locks the terminal device against use.

### BACKGROUND OF THE INVENTION

1. Field of the Invention

The present invention relates to a terminal lock system for verifying that the user of a terminal device is a person with the legitimate right to use the terminal device for thereby protecting the terminal device against unauthorized use by a third party.

2. Description of the Related Art

In recent years, a variety of terminal devices including personal computers, PDAs, cellular phones, etc. are finding widespread use among many users. The terminal devices often have important personal information stored therein and need to be protected against unauthorized use by persons other than lawful users thereof.

There have heretofore been various schemes for making personal authentication to permit such terminal devices to be used only by lawful users for protection against unauthorized use of those terminal devices. According to one authentication process, a terminal device requires the user to enter a password to identify the lawful user. This process is, however, not highly convenient for the user, causes a problem as to the management of the password, and is complex to carry out.

According to other schemes, an ID card is used to authenticate the user of a terminal device, and a one-time password that is valid at one time only when the user uses a terminal device is automatically issued for the user to enter to use the terminal device. However, using the ID card is a rather tedious and time-consuming task to perform. When the user leaves the terminal device, the user needs to remove the ID card from the terminal device, and when the user uses the terminal device, the user needs to insert the ID card into the terminal device. If the user forgets to remove the ID from the terminal device and leaves the terminal device, then the terminal device becomes vulnerable to unauthorized use by a third party. If the terminal device is a cellular phone, then since it is usually necessary to keep the cellular phone in operation while waiting for incoming calls, the ID card is expected to be inserted in the cellular phone at all times during the waiting mode. Therefore, when the user loses the cellular phone with the ID card inserted therein, it is open to unauthorized use by a third party.

There are known personal authentication techniques that employ biological characteristics such as fingerprints, voiceprints, iris patterns, etc. for authentication. At present, however, these personal authentication techniques need highly costly devices, and are too expensive to be practically feasible solely for authentication purposes in various terminal devices.

Other conventional proposals for preventing unauthorized use of terminal devices include a system disclosed in Japanese laid-open patent publication No. 08-162994 entitled “Radio communication unit having a function to prevent unauthorized use”. The disclosed system gives a command to the radio communication unit to inhibit unauthorized use thereof from a remote location thereby disabling the radio communication unit in the event that the radio communication unit is lost or stolen. According to the disclosed prior art, since the radio communication unit is instructed against use by a radio signal, the system cannot transmit an inhibitory command to the radio communication unit unless the radio communication unit is turned on and positioned within a range that is reachable by the radio signal. Furthermore, the system requires the user to make an action to inhibit the radio communication unit from use. If the system is applied to a situation for making a personal computer not usable while the user is away, then the action made by the user tends to be more complex than if the user were asked to enter a password for authentication, and is not practical.

According to the conventional schemes described above, therefore, the user of the terminal device needs to make a complex action in order to prevent a third party from making unauthorized use of the terminal device. If the user has inadvertently made the password known or lost the terminal device together with the ID card, then it is impossible to reliably prevent unauthorized use of the terminal device by a third party.

### SUMMARY OF THE INVENTION

It is therefore an object of the present invention to provide a terminal lock system and a terminal lock method which are able to authenticate the lawful user of a terminal device without the need for the user to make a complex action for thereby reliably preventing a third party from making unauthorized use of the terminal device.

To achieve the above object, there is provided a terminal lock system for verifying that the user of a terminal device is a person with the legitimate right to use the terminal device for thereby protecting the terminal device against unauthorized use by a third party, the terminal lock system comprising a key device and a terminal-associated device.

The key device is portable and has a radio communication means for performing short-range radio communications. The terminal-associated device requests a connection to the key device through the short-range radio communications, and inhibits the terminal device which is combined with the terminal-associated device from being used if information of the key device which is confirmed as being connected to the terminal-associated device does not agree with information registered in the terminal-associated device, or if the terminal-associated device is not confirmed as being connected to the key device through the short-range radio communications.

With the above arrangement, when the user who is carrying the key device moves away from the terminal device combined with the terminal-associated device until the terminal-associated device and the key device are no longer capable of connecting to each other based on a short-range radio communication technique, the terminal-associated device locks the terminal device against use. The terminal lock system thus authenticates the user without the need for asking the user to make any action, and reliably protects the terminal device against unauthorized use by a third party.

The key device may register information of the terminal-associated device in advance therein, and the key device may connect to the terminal-associated device through the short-range radio communications only when the information registered in the terminal-associated device which has requested a connection to the key device and the information registered in the key device agree with each other.

If a device in which the information of the key device is not registered requests a connection to the key device, then no short-range radio communications are carried out for thereby making the terminal lock system more reliable.

The key device may start the short-range radio communications with the terminal-associated device only when a predetermined action is made thereon.

Since the key device is brought from an inactivated state into a waiting mode for waiting for a radio connection when the user makes a predetermined action on the key device to use the key device, the consumption of electric energy by the key device is reduced, and the life of a battery of the key device is extended.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a block diagram of a terminal lock system according to a first embodiment of the present invention;

FIG. 2 is a flowchart of an operation sequence of a terminal-associated device of the terminal lock system shown in FIG. 1;

FIG. 3 is a flowchart of an operation sequence of a key device of the terminal lock system shown in FIG. 1; and

FIG. 4 is a block diagram of a terminal lock system according to a second embodiment of the present invention.

### DETAILED DESCRIPTION OF THE PREFERRED EMBODIMENTS

1st Embodiment:

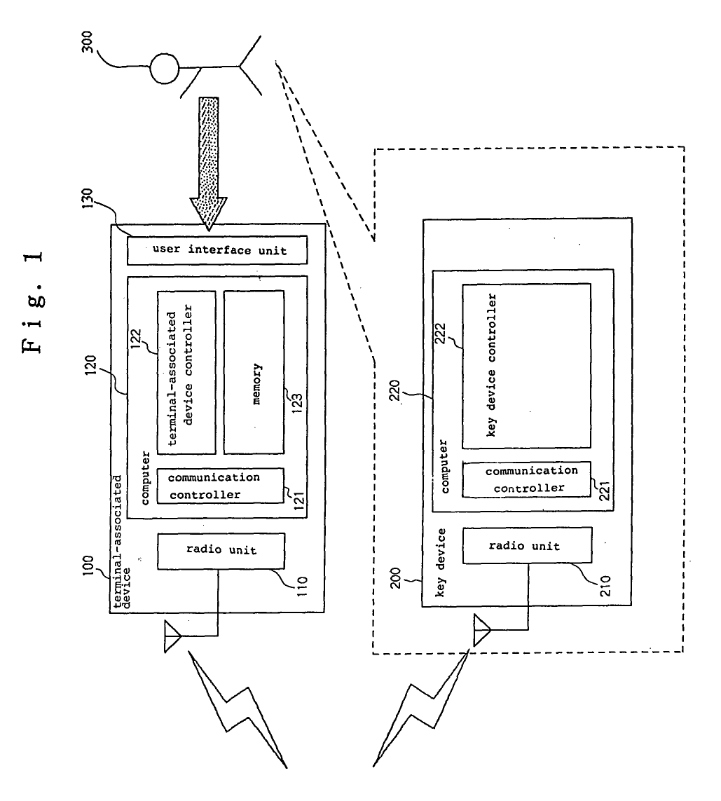

FIG. 1 shows in block form a terminal lock system according to a first embodiment of the present invention. The terminal lock system according to the first embodiment of the present invention is a system for simply performing personal authentication and preventing a person other than the lawful owner from using a terminal device without permission, based on a short-range radio communication technique such as Bluetooth, radio LAN, or the like.

As shown in FIG. 1, the terminal lock system comprises terminal-associated device 100 and key device 200. Terminal-associated device 100 is added to or incorporated in an information-related terminal device such as a personal computer, PDA, a cellular phone, or the like that needs to be protected. Key device 200 is carried at all times by the lawful owner of the terminal device, and is added to or incorporated in a cellular phone, a PDA, a wrist watch, a badge, a key holder, or the like. The cellular phone or the PDA may serve as a device on which terminal-associated device 100 is mounted or a device on which key device 200 is mounted.

A summary of operation of the terminal lock system according to the first embodiment of the present invention will be described below. Information of key device 200 is registered in advance in terminal-associated device 100. Key-associated unit 200 is placed at all times in a mode for waiting for an attempt from terminal-associated device 100 to connect to key device 200. After terminal-associated device 100 is turned on, it attempts to connect to key device 200 via a short-range radio communication link. If key device 200 is positioned in a range capable of radio communications with terminal-associated device 100, then since key device 200 and terminal-associated device 100 are successfully connected, key device 200 acquires a right to use terminal-associated device 100. Thus, once information of key device 200 is registered in terminal-associated device 100, key device 200 can subsequently use terminal-associated device 100 insofar as key device 200 is in the range capable of radio communications with terminal-associated device 100 based on the short-range radio is communication technique such as Bluetooth, radio LAN, or the like. As a result, when the owner who is carrying key device 200 at all times is not located in the radio communication range, the terminal device cannot be used. For example, if the owner has lost a cellular phone as the terminal device, then the cellular phone cannot be used unless the key device is located in the radio communication range. If the owner is away from a notebook personal computer as the terminal device, then the notebook personal computer is not open to unauthorized use unless the key device is located in the radio communication range.

Details of the terminal lock system according to the first embodiment of the present invention will be described below. As shown in FIG. 1, the terminal lock system comprises terminal-associated device 100 that is combined with a terminal device and key device 200 that is carried by user 300, most likely the owner thereof.

Actually, terminal-associated device 100 is added to or incorporated in a terminal device such as a personal computer, a PDA, a cellular phone, or the like, which should have limited access, i.e., cannot be used by persons other than the owner. Similarly, key device 200 is added to or incorporated in a device such as a cellular phone, a PDA, a wrist watch, a badge, a key holder, or the like that is carried by the owner at all times. The cellular phone or the PDA may serve as a device on which terminal-associated device 100 is mounted or a device on which key device 200 is mounted.

Terminal-associated device 100 comprises radio unit 110 for performing short-range radio communications based on a technique such as Bluetooth, radio LAN, or the like, computer (central processing unit) 120 which operates under programmed control, and user interface unit 130. Key device 200 comprises radio unit 210 for performing short-range radio communications based on a technique such as Bluetooth, radio LAN, or the like, and computer (central processing unit) 220 which operates under programmed control.

Computer 120 includes communication controller 121, terminal-associated device controller 122, and memory 123. Similarly, computer 220 includes communication controller 221 and key device controller 222.

Communication controller 121 has a radio control function for controlling radio unit 110 and a function to perform communications using a communication protocol that is suitable for a radio technique that is employed. In order to connect to key device 200 as instructed by terminal-associated device controller 122, communication controller 121 instructs radio unit 110 to connect to key device 200, and returns a notification indicating that the connection has been successful or failed to terminal-associated device controller 122.

At the time terminal-associated device 100 is activated, terminal-associated device controller 122 checks if information of key device 200 is registered in memory 123 or not. If information of key device 200 is not registered in memory 123, then terminal-associated device controller 122 keeps terminal-associated device 100 usable, and waits until user 300 instructs terminal-associated device 100 via user interface unit 130. Conversely, if information of key device 200 is registered in memory 123, then terminal-associated device controller 122 locks the terminal device against use. Thereafter, according to the registered information, terminal-associated device controller 122 instructs communication controller 121 to connect to key device 200. If notified of a connection success from communication controller 121, then terminal-associated device controller 122 makes terminal-associated device 100 usable. If notified of a connection failure from communication controller 121, then terminal-associated device controller 122 keeps terminal-associated device 100 unusable to inhibit the terminal device from use.

Terminal-associated device controller 122 is also instructed by user 300 via user interface unit 130 to register, delete, and edit information of key device 200. If terminal-associated device controller 122 is instructed by user 300 to register information of key device 200, then terminal-associated device controller 122 instructs communication controller 121 to connect to key device 200. If notified of a connection success from communication controller 121, then terminal-associated device controller 122 registers and stores information of key device 200 in memory 123, and indicates to user 300 via user interface unit 130 that the registration of information of key device 200 has been successful. If notified of a connection failure from communication controller 121, then terminal-associated device controller 122 indicates to user 300 via user interface unit 130 that the registration of information of key device 200 has failed.

Communication controller 221 has a has a radio control function for controlling radio unit 210 and a function to perform communications using a communication protocol that is suitable for a radio technique that is employed. When instructed by key device controller 222, communication controller 221 instructs radio unit 210 to wait for a connection from terminal-associated device 100. Key device controller 222 instructs communication controller 221 to wait for a connection from terminal-associated device 100.

An overall operation sequence of the terminal lock system according to the first embodiment of the present invention will be described below with reference to FIGS. 1 through 3.

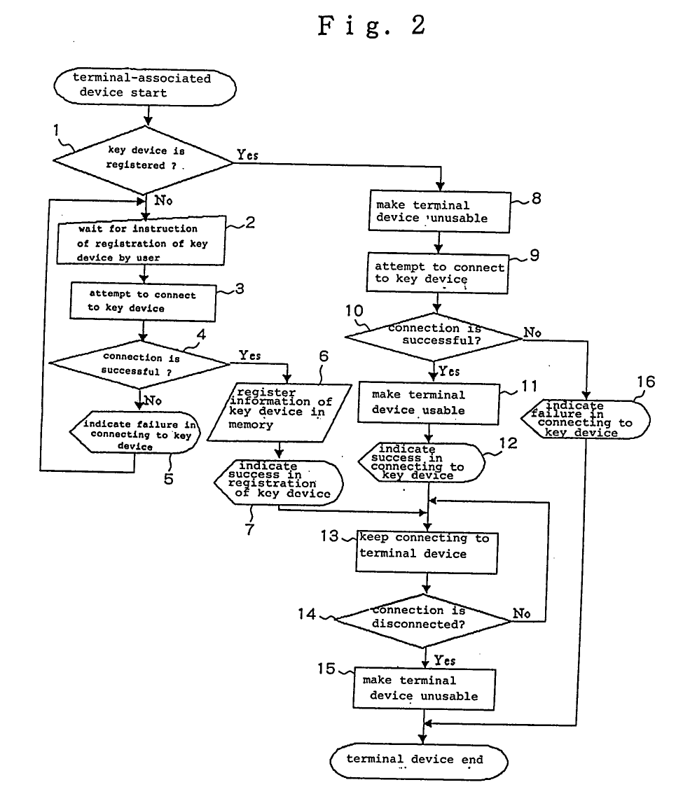

First, operation of terminal-associated device 100 will be described below with reference to FIG. 2.

When terminal-associated device 100 is activated, terminal-associated device controller 122 refers to memory 123 to check whether information of key device 200 is registered in memory 123 or not in step 1. Since information of key device 200 is initially not registered in memory 123, terminal-associated device 100 keeps the terminal device usable, and waits for an input from user 300 in step 2. Memory 123 comprises a nonvolatile memory that is capable of storing information semipermanently. Alternatively, memory 123 may comprise a volatile memory if it can read information from an external memory when terminal-associated device 100 is activated.

In step 2, user 300 instructs, via user interface unit 130, terminal-associated device controller 122 to register information of key device 200 in memory 123. In order to specify key device 200, the terminal lock system may have a means for entering inherent information of key device 200 directly from user interface unit 130 or may have a means for generating a list of nearby devices based on a device search function according to the radio communication technique that is employed and selecting one of the devices in the list.

In step 3, in response to the instruction from user 300 to register information of key device 200, terminal-associated device controller 122 controls radio unit 110 to connect to key device 200 according to an appropriate radio communication protocol. Information for specifying key device 200 may be a production serial number inherent in key device 200, an address inherent in key device 200, or a software-based identification number inherent in key device 200 insofar as it is capable of uniquely identifying key device 200 through at least radio communications.

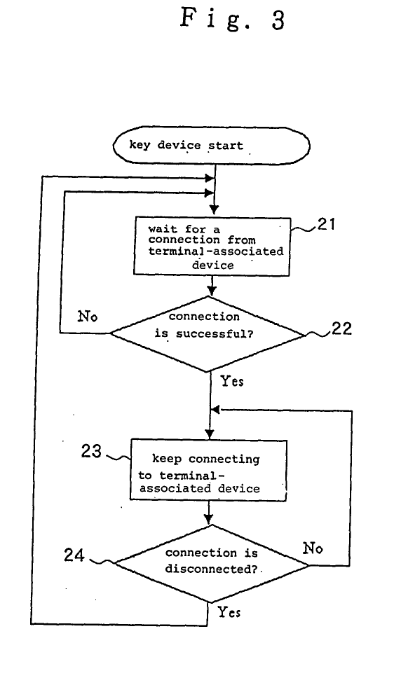

Operation of key device 200 will be described below with reference to FIG. 3.

In step 21 shown in FIG. 3, when key device 200 is turned on, key device controller 222 instructs communication controller 221 to wait for a connection from terminal-associated device 100. As instructed, communication controller 221 waits until a connection comes from terminal-associated device 100.

In step 3 shown in FIG. 2, a connection from radio unit 110 of terminal-associated device 100 is received by radio unit 210 of key device 200, and communication controller 121 and communication controller 221 carry out a process to connect to each other according to the respective radio communication protocols thereof. Thereafter, key device 200 determines whether a connection is successful or not in step 22.

If a connection is successful, then key device 200 keeps itself connected to terminal-associated device 100 in step 23. At this time, key device 200 keeps itself connected to terminal-associated device 100 with a minimum consumption of electric energy that is achieved by a power saver scheme inherent in the employed ratio communication technique.

If the connection is broken in step 24, then control goes back to step 21 immediately following the activation of key device 200, and key device controller 222 instructs is communication controller 221 to wait for a connection from terminal-associated device 100. If the connection is not broken in step 24, then key device 200 keeps itself connected to terminal-associated device 100 in step 23.

Operation of terminal-associated device 100 will be described again with reference to FIG. 2.

Communication controller 121 indicates a success or a failure in connecting to key device 200 in step 3 to terminal-associated device controller 122. If a success in connecting to key device 200 is indicated to terminal-associated device controller 122 in step 4, then terminal-associated device controller 122 registers information of key device 200 in memory 123 in step 6. The information of key device 200 that is registered in memory 123 must be information for identifying key device 200. If possible, a special calculation that cannot easily be forged should be carried out on such information for identifying key device 200 and the result should be registered as the information of key device 200 in memory 123.

Thereafter, terminal-associated device controller 122 indicates that the registration of the information of key device 200 has been successful to user 300 via user interface unit 130 in step 7.

If a failure in connecting to key device 200 is indicated to terminal-associated device controller 122 in step 4, then terminal-associated device controller 122 indicates that the registration of the information of key device 200 has failed to user 300 via user interface unit 130 in step 5. Thereafter, in step 2, terminal-associated device 100 while being kept usable waits for an input from user 300 to attempt to register information of key device 200 again in memory 123.

If information of key device 200 has already been registered in memory 123 in step 1 shown in FIG. 2, then terminal-associated device controller 122 makes terminal-associated device 100 unusable in step 8.

While keeping terminal-associated device 100 unusable, terminal-associated device controller 122 attempts to connect to key device 200 via radio unit 110 according to an appropriate radio communication protocol in step 9. The information for specifying key device 200 may be a production serial number inherent in key device 200, an address inherent in key device 200, or a software-based identification number inherent in key device 200. If a special calculation has been carried out on such information for identifying key device 200, then an inverse calculation is carried out to obtain the original information. At any rate, the information should be capable of uniquely identifying key device 200 through at least radio communications.

Communication controller 121 indicates a success or a failure in connecting to key device 200 in step 9 to terminal-associated device controller 122. If a success in connecting to key device 200 is indicated to terminal-associated device controller 122 in step 10, then terminal-associated device controller 122 makes terminal-associated device 100 usable in step 11.

Thereafter, terminal-associated device controller 122 indicates to user 300 via user interface unit 130 that the connection to key device 200 has been successful and terminal-associated device 100 is usable in step 12.

In step 13, terminal-associated device 100 keeps itself connected to key device 200. At this time, terminal-associated device 100 usually keeps itself connected to key device 200 with a minimum consumption of electric energy that is achieved by a power saver scheme inherent in the employed ratio communication technique. In this manner, user 300 can use the terminal device only when terminal-associated device 100 and key device 200 are connected to each other by a radio communication link.

If the connection to key device 200 is broken in step 14, then terminal-associated device controller 122 makes terminal-associated device 100 unusable in step 15. When step 15 is reached, the terminal lock system is considered to be in a situation where the use of terminal-associated device 100 is ended and the power supply thereof is readied to be turned off. However, if the radiation communications are turned off abnormally, then the connection between terminal-associated device 100 and key device 200 should automatically be recovered. Terminal-associated device 100 should be made unusable only when it is impossible to recover the connection between terminal-associated device 100 and key device 200. Insofar as the connection to key device 200 is not broken in step 14, terminal-associated device 100 usually keeps itself connected to key device 200 in step 13.

If a failure in connecting to key device 200 is indicated from communication controller 121 to terminal-associated device controller 122 in step 10, then terminal-associated device controller 122 indicates to user 300 via user interface unit 130 that the connection to key device 200 has failed and terminal-associated device 100 is not usable in step 16. In this case, terminal-associated device 100 naturally remains unusable.

With the terminal lock system according to the first embodiment of the present invention, though key device 200 needs to be authenticated once when it is registered, after key device 200 is registered, the user of the terminal device is automatically authenticated as long as the user carries authenticated key device 200 at all times. Therefore, the user can be authenticated to use the terminal device without recognizing that the user is authenticated. Therefore, the user can unconsciously be personally authenticated without the need for making a complex action.

With the terminal lock system according to the first embodiment of the present invention, in addition, the terminal device can be used only if the authenticated key device is in the radio communication range. Therefore, even when the user has lost a cellular phone as the terminal device, other persons cannot make unauthorized use of the cellular phone unless the key device is in the radio communication range. Consequently any other persons than the user are prevented from making unauthorized use of the terminal device. Since the key device and the terminal device are connected to each other via short-range radio communications, it is almost impossible for the key device and the terminal device to be lost at the same time. As a result, even if the user has lost the terminal device, unauthorized use of the terminal device by a third party is reliably prevented.

With the terminal lock system according to the first embodiment of the present invention, furthermore, neither the key device nor the terminal-associated device depends upon the communication means used therebetween. Accordingly, any short-range radio communication techniques that are generally in widespread use can be used for the terminal lock system with compatibility maintained only by software modifications. The present invention is based on the mere concept that the key device and the terminal-associated device may be connected to each other. The present invention should allow systems in different companies to be connected with each other with high probability insofar as they employ the same radio communication technique. If such systems in different companies can be connected with each other, then the terminal lock system according to the present invention can be realized. Inasmuch as each of the terminal-associated device and the key device does not need to recognize how the other device has registered information of its own, there are few matters to be taken into account for mutual connectability between the terminal-associated device and the key device. Therefore, systems in different companies can be easily be interlinked.

Because neither the key device nor the terminal-associated device depends upon the communication means used therebetween as describe above, any short-range radio communication techniques that are generally in widespread use can be used for the terminal lock system. If devices of the terminal lock system have already employed a short-range radio communication technique for other purposes, then the terminal lock system can be realized by simply adding software for those devices. As the employed short-range radio communication technique can be used for other purposes, rather than authentication purposes only, the user finds an additional value in the terminal lock system. The terminal lock system is technically simple in system arrangement and low in cost.

2nd Embodiment:

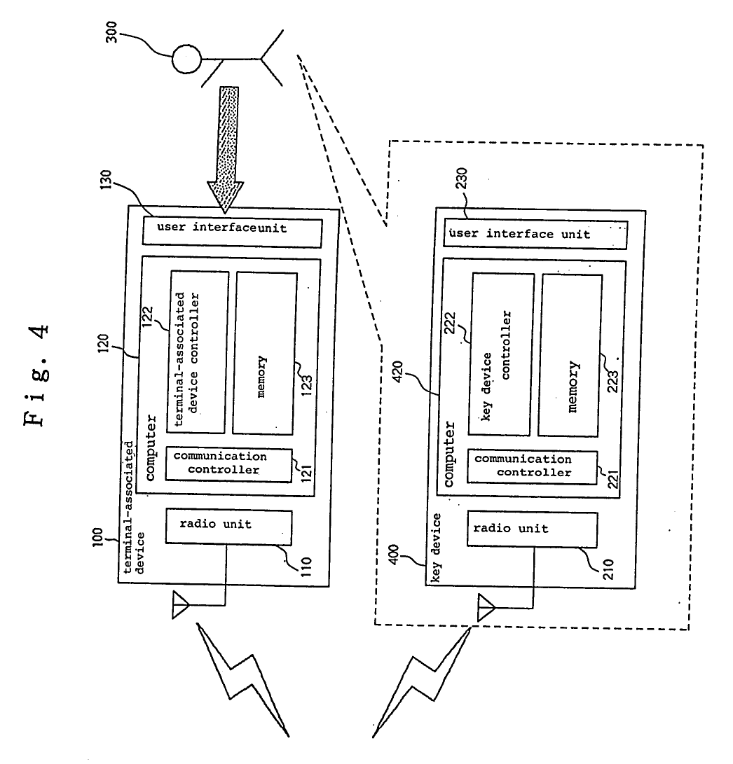

A terminal lock system according to a second embodiment of the present invention will be described below with reference to FIG. 4. Those parts of the terminal lock system shown in FIG. 4 which are identical to those of the terminal lock system shown in FIG. 1 are denoted by identical reference characters, and will not be described in detail below.

As shown in FIG. 4, the terminal lock system comprises terminal-associated device 100 and key device 400.

Key device 4 comprises radio unit 210, computer 420, and user interface unit 230. Computer 420 is different from computer 220 of key device 200 shown in FIG. 1 in that it additionally has memory 223.

With the terminal lock system according to the first embodiment of the present invention, key device 200 stores no information whatsoever, and only waits for a connection from terminal-associated device 100. Therefore, key device 200 may possibly be connected from an unintended device. According to the second embodiment, memory 223 of computer 420 allows key device 400 to register information of terminal-associated device 100. Based on the information of terminal-associated device 100 registered in memory 223, key device 400 can ignore a connection from an unintended device, or can notify user 300. For example, even when a malicious third party attempts to connect to key device 400 for the purpose of obtaining information of key device 400, the terminal lock system according to the second embodiment is effective to prevent such a malicious third party from knowing information of key device 400.

In the first and second embodiments, no conditions are provided for connecting terminal-associated device 100 and key devices 200, 400. However, a password or the like may be used in establishing a connection between terminal-associated device 100 and key devices 200, 400 at the time their information is registered, for thereby establishing a more reliable relationship therebetween. Though entering a password or the like is somewhat troublesome for the user, it should not be too burdensome as it needs to be entered only once when the information of the key devices 200, 400 is registered. Key device 400 shown in FIG. 4 includes user interface unit 130. Since user interface unit 130 allows user 300 to enter information into key device 400, a password can be exchanged between terminal-associated device 100 and key device 400 for thereby establishing a more reliable relationship therebetween. If information to be registered is generated according to a special calculation using information that only the user is aware of, e.g., a password, in addition to information inherent in the device, i.e., a production serial number, an address, and a software-based identification number, the possibility that the user is prevented from being impersonated by another person is increased. A much more reliable relationship can be achieved by regenerating the registered information periodically or at certain timings. Terminal-associated device 100 and key devices 200, 400 may agree to each other to exchange secret information that only they are aware of when they are connected to each other, thus establishing a more reliable relationship therebetween. Naturally, in view of the security as a weak point of radio communications, the information that needs to be exchanged may be encrypted to guard against other parties.

In the first and second embodiments, it has been described that only information of key device 200, 400 is registered in memory 123 of terminal-associated device 100. However, such a description is illustrative only, and memory 123 of terminal-associated device 100 may register therein information of a plurality of key devices. In such a modification, the information of key devices registered in memory 123 may be checked in a sequence or at one time, and if terminal-associated device 100 can connect to one of the key devices whose information is registered, then the connected key device can be made usable. Similarly, in the terminal lock system where key device 400 has memory 223 according to the second embodiment, memory 223 may register therein information of a plurality of key devices.

Although not described in the above first and second embodiments, user interface unit 130 of terminal-associated device 100 or user interface unit 230 of key device 400 allows additional information representing a registration title, a date of registration, and an effective period to be added to the registered device information for the convenience of the user, and also allows information to be protected, added, deleted, and edited.

In the first and second embodiments, it has been described that the terminal device can be used only while terminal-associated device 100 and key devices 200, 400 are being connected to each other. However, the above description merely represents a rule introduced for simplifying the illustration. The principles of the present invention are based on whether both terminal-associated device 100 and key devices 200, 400 are in the radio communication range or not, and do not necessarily assume that terminal-associated device 100 and key devices 200, 400 have to be connected to each other at all times. One of these devices may be capable of confirming that the other device is in the radio communication range based on a device search function according to the short-range radio communication technique that is employed. Specifically, the devices may be connected only once at first for authentication purpose, and if the connection is successful, they may be disconnected, and thereafter one of these devices may confirm that the other device is in the radio communication range based on the device search function according to the employed short-range radio communication technique. According to a further modification, even the devices may not be connected once at first for authentication purpose, but one of these devices may confirm that the other device is in the radio communication range based on the device search function at periodic intervals. These processes described above fall within the scope of the present invention.

In the first and second embodiments, it has been described that the terminal lock system automatically starts operating immediately after terminal-associated device 100 and key devices 200, 400 are activated. However, the terminal lock system may start operating at other timings than the activation of terminal-associated device 100 and key devices 200, 400. For example, the terminal lock system may be applied to the control of a screen saver of a personal computer. Specifically, when the user of a personal computer walks away from personal computer and out of the radio communication range, the screen saver of the personal computer is automatically activated and the personal computer is locked, thus preventing other persons from peeking into the personal computer or from making unauthorized actions on the personal computer. When the user walks back into the radio communication range, the screen saver is disabled, and the personal computer is unlocked for use again.

In the first and second embodiments, it has also been described that key device 200, 400 waits for a radio connection at all times. However, if such a waiting mode is not preferred from the standpoint of electric energy consumption, then key device 200, 400 may be usually inactivated, and may be brought into a waiting mode for waiting for a radio connection when it is activated by a simple action such as a touch on a key on key device 200, 400. Though the above process is somewhat less convenient than the fully automatic terminal lock system because the user needs to be conscious of authentication, the life of the battery used in key device 200, 400 can be extended simply by touching a key on key device 200, 400.

While preferred embodiments of the present invention have been described using specific terms, such description is for illustrative purposes only, and it is to be understood that changes and variations may be made without departing from the spirit or scope of the following claims.

What is claimed is:

1. A terminal lock system for verifying that the user of a terminal device is a person with the legitimate right to use the terminal device for thereby protecting the terminal device against unauthorized use by a third party, comprising:
a key device which is portable, said key device having radio communication means for performing short-range radio communications; and
a terminal-associated device for requesting a connection to said key device through the short-range radio communications, and inhibiting the terminal device combined with said terminal-associated device from being used if information of the key device which is confirmed as being connected to said terminal-associated device does not agree with information registered in the terminal-associated device, or if said terminal-associated device is not confirmed as being connected to the key device through the short-range radio communications.

2. A terminal lock system according to claim 1, wherein said key device starts the short-range radio communications with said terminal-associated device only when a predetermined action is made thereon.

3. A terminal lock system according to claim 1, wherein said key device registers information of said terminal-associated device in advance therein, and said key device connects to said terminal-associated device through the short-range radio communications only when the information registered in the terminal-associated device which has requested a connection to said key device and the information registered in said key device agree with each other.

4. A terminal lock system according to claim 3, wherein said key device starts the short-range radio communications with said terminal-associated device only when a predetermined action is made thereon.

5. A method of locking a terminal device for verifying that the user of the terminal device is a person with the legitimate right to use the terminal device for thereby protecting the terminal device against unauthorized use by a third party, comprising the steps of:
registering information of a key device which is portable in a terminal-associated device combined with the terminal device, said key device having radio communication means for performing short-range radio communications;
requesting a connection to said key device through the short-range radio communications from said terminal-associated device; and
inhibiting the terminal device combined with said terminal-associated device from being used if information of the key device which is confirmed as being connected to said terminal-associated device does not agree with information registered in the terminal-associated device, or if said terminal-associated device is not confirmed as being connected to the key device through the short-range radio communications.

6. A method according to claim 5, wherein said key device starts the short-range radio communications with said terminal-associated device only when a predetermined action is made thereon.

7. A method according to claim 5, further comprising the step of:
connecting said key device to said terminal-associated device through the short-range radio communications only when the information registered in the terminal-associated device which has requested a connection to said key device and the information registered in said key device agree with each other.

8. A method according to claim 7, wherein said key device starts the short-range radio communications with said terminal-associated device only when a predetermined action is made thereon.
